(19) United States
(12) Patent Application Publication
(10) Pub. No.: US 2002/0178919 A1
(43) Pub. Date: Dec. 5, 2002

(54) Centripetal gas purifying system and method

(76) Inventor: Charles C. Miles, Idaho Falls, ID (US)

Correspondence Address: Alan D. Kirsch, 734 E. Countryside Lane, Idaho Falls, ID, 83404, US

(21) Appl. No.: 10/199,735

(22) Filed: Jul. 18, 2002

Related U.S. Application Data
(63) Continuation-in-part of application No. 09/766,986, filed on Jan. 22, 2001, now Pat. No. 6,451,093.

(51) Int. Cl. B01D 46/00

(52) U.S. Cl. 95/268; 95/212; 95/277; 95/281; 96/233; 55/400

(57) ABSTRACT

A method and system for removing particles from a particulate laden gas stream through the use of centripetal and centrifugal forces. A rotating shaft and brushes create centrifugal force upon particulates within the gas, while a centripetal force created by a pressure differential, directs the gas radially inward. The centripetal force may be created and maintained by self-pumping means driven by a rotating shaft. Rinsing means are provided for periodically rinsing particles accumulated within the bristles.

This is a continuation-in-part of U.S. application Ser. No 09/766,986, filed Jan. 22, 2001, now U.S. Pat. No. ______.

### TECHNICAL FIELD

This invention relates to a system and method for removing particulates from a gaseous stream and more particularly to removing particulates from a gaseous stream through the use of centrifugal and centripetal forces.

### BACKGROUND OF THE INVENTION

In my U.S. patent application Ser. No. 09/766,986, which is incorporated herein by reference, a method and apparatus for separating particulates from a moisture laden gas stream using centrifugal and centripetal force were described. In that invention, a rotating core having bristles attached thereto, creates a centrifugal force upon moisture and particles contained within a moisture laden gas stream, thereby separating the moisture and particles from the gas. A centripetal force is created by maintaining a pressure differential between the housing gas inlet and the interior of the rotating core, thereby causing the gas to be directed towards an interior axis of the core and thereupon exiting the system through the hollow core interior. It was desirable that the gas contain some level of moisture to facilitate the separation of particles from the gas stream. An optional inlet moisturizing system was provided to maintain a desired level of moisture within the gas stream entering the device.

In the present invention, a gas purification system and method are provided which utilize centrifugal and centripetal forces to remove particulates from a gas stream without the requirement of the gas containing moisture. The present invention is capable of removing particles from any gas over a wide range of temperatures and pressures. Illustrative of the types of particles that can be removed from a gas stream, include, but are not limited to, dust, clay, smog, fog, resin smoke, oil smoke, tobacco smoke, bacteria, viruses, carbon black, fly ash, metallurgical dust fumes, ammonium chloride fumes, coal dust, insecticide dusts, ground talc, zinc oxide fumes, sulfuric acid mists, alkali fumes, paint pigments, colloidal silica, atmospheric dusts, atmospheric soot, asbestos dust and all other forms of chemical fumes and mists.

It is an object of the present invention to provide a system and method for removing particles from a gas using centripetal and centrifugal forces.

It is another object of the present invention to provide a system and method for removing particles from a gas using centripetal and centrifugal forces whereby the centripetal force is maintained through self-pumping means.

It is another object of the present invention to provide a system and method for removing particles from a gas using centripetal and centrifugal forces irrespective of the moisture content of the gas.

It is still another object of the present invention to provide a gas purification method and system that can be economically maintained and cleaned during operation.

### SUMMARY OF THE INVENTION

The invention provides a method and system for purifying a gas using centripetal and centrifugal forces. The method for removing particulates from a gas comprises directing a particulate laden gas into a housing at a first pressure; rotating a hollow core within the housing, the hollow core having bristles attached thereto, and further having holes along a portion of the core; maintaining a second pressure within an interior of the hollow core, the second pressure being less than said the first pressure thereby creating a centripetal force upon the entering gas toward the hollow core interior, the gas then entering the core interior through holes/ports in the core; creating a centrifugal force from the rotating core and bristles whereby the rotating bristles contact the particulates contained in the gas and direct the particulates away from the core toward interior walls of the housing; exhausting purified gas from the interior of the hollow core; and removing accumulated particulates from within the housing.

The system of the present invention comprises a housing having first and second ends, each end having an aperture, the housing further having at least one gas inlet through which a gas containing particulates enters the housing at a first pressure; a rotatable hollow core within the housing, a portion of the core having holes or slots, a pressure within the core being less that the first gas pressure; bristles removably attached to, and extending from the core; a rotation system drivably rotating the hollow core and bristles thereby creating a centrifugal force to direct particulates contacted by the rotating bristles toward an inner surface of the housing, while gas flows under centripetal force toward an axis of the core; a waste collection system connected to said housing for collecting and removing accumulated particulates within said housing.

An optional rinsing system is also provide to remove particles embedded within the bristles. The rinse system can be adapted within the interior of the core, the atomized rinsing fluid flowing through the core holes due to centrifugal force and thereupon removing particles embedded in the bristles. Alternatively, the rinse can be directed to the periphery of the rotating bristles. It is preferred that the rinse be in the form of fine droplet size and distributed relatively uniformly to facilitate particulate removal.

Another optional feature of the present invention is the use of a rotating pump, directly driven by the rotating shaft, the pump thereby creating and maintaining the desired pressure and gas throughput.

### BRIEF DESCRIPTION OF THE DRAWINGS

Preferred embodiments of the invention are described below with reference to the accompanying drawing, which is briefly described below.

FIG. 1 is an elevational view, partly in section, of a system according to the invention.

### DETAILED DESCRIPTION OF THE PREFERRED EMBODIMENTS

In the following description, similar components are referred to by the same reference numeral in order to simplify the understanding of the sequential aspect of the drawings.

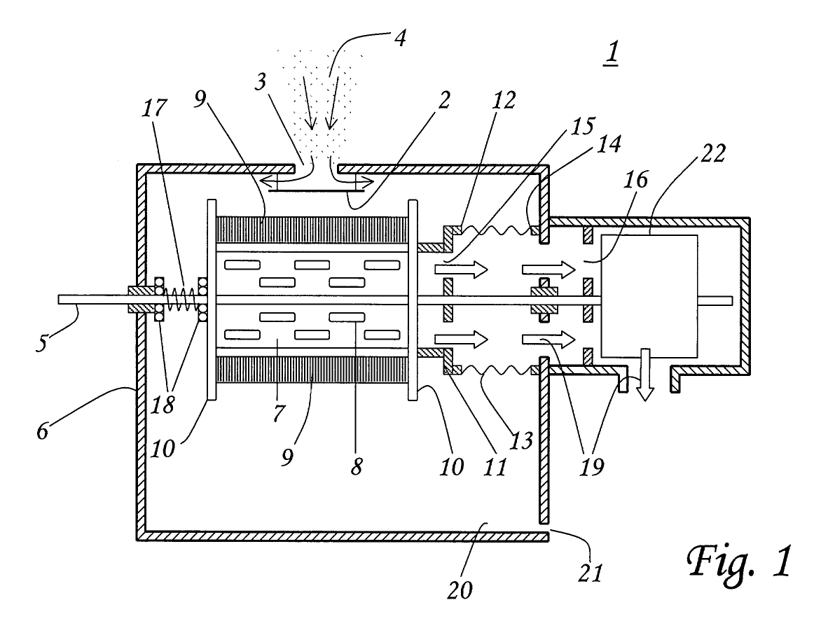

Referring now to FIG. 1, an elevational view, partly in section, of the present invention gas purification system 1 is shown. The gas purification system 1 comprises a housing 6 having at least one gas inlet 3 through which particulate laden gas 4 enters the housing 6 where it is dispersed by an optional baffle 2. A drive shaft 5 is adapted through the housing 6. Within housing 6 is a hollow core 7 connected to, and axially aligned with drive shaft 5. The hollow core 7 has one or more ports 8 through which gas may flow. Removably attached to the hollow core 7 are stiff bristles 9.

The bristles 9 can be attached to the hollow core 7 in many different manners. For example, in one embodiment the bristles 9 are axially aligned along a length of the core 7. This may be accomplished by means of a groove in the core through which a brush mount can be secured. (As used herein the term “brush” is understood to mean multiple bristles.) It has been found that this flat brush arrangement has advantages over the use of circular brushes since the bristles of a circular brush tend to flatten out and open an unswept pathway through the bristles to the core. This decreases particle removal efficiency at higher rotation speeds. However, circular brush efficiency can be maintained at a high rotation speed by providing filler-plates spaced periodically along the length of the core to prevent the circular brushes from flattening during high speed rotation. FIG. 1 illustrates two plate mounts 10 at opposing ends of bristles. However, plate mounts can be positioned periodically along the length of the bristles. The plate mounts provide a means for dynamically balancing the entire brush assembly and to direct the gas flow through the brush by diverting the flow from the ends of the brush through the bristles.

Alternatively the bristles 9 can be comprised of multiple tufts mounted on the core 7 with core ports surrounding each tuft. Still another way to mount the bristles 9 to the core 7 is to provide bristles 9 surrounding the periphery of each core port 8. One skilled in the art will recognize that there are many other methods of securing the bristles 9 to the rotating core 7.

The bristles 9 can be made of any material that has sufficient stiffness to continue to extend from the core 7 during the rotation. Examples of materials that can be used as bristles include, but are not limited to hair, wire, and fiber. The bristles 9 can be crimped, crinkled, straight, or bunched (e.g., like steel wool). Generally the length of the individual bristle is always greater than its diameter.

The number, size and geometry of ports 8 through the core 7 will dictate the back pressure level developed by the whole brush assembly and core due to the flow of gas from the periphery of the brushes to the openings/ports in the core. These ports 8 may be round, square, rectangular, triangular, polygonal, slots, or random cuts in the core 7 provided that this does not weaken the structural integrity of the core 7. Gas flow may be enhanced by mounting the brushes separately on individual frames and allowing spaces between them so as to give free air passage. This arrangement provides reduced back pressure when flat brushes are mounted to give an open space between the base of each brush. The core design having brushes mounted on separate frames has the advantage of reducing the core mass.

An example for exhausting purified gas 19 from the housing 6 is illustrated in FIG. 1, it being recognized that other means for segregating purified gas 19 from the particulate laden gas 4 may also be used. The core 7 and housing 6 each have at least one exhaust port 15 and 16 respectively, from which purified gas 19 exits the core 7 and housing 6 and can be collected, further processed, or vented depending upon the particular application. The exhaust ports 15 and 16 are isolated from the particulate laden gas by a bearing plate 11, carbon ring seal 12, flexible bellows 13 and bellows support ring 14. Spring 17 is used to maintain the core 7 in position relative to the carbon ring 12, and flexible bellows 13.

In one embodiment of the invention, an optional brush washing system is provided. Rinse fluids sprayed periodically onto the brush will remove imbedded particles, thereby improving the efficiency of the gas purifying systems and extend the brush life considerably. Also, the rinse fluid washes the particles accumulated within the housing walls and down into a sump from which they can be removed from the system through drain 21. The optional brush washing system would require the use of sealed bearings, such as a bearing plate carbon ring seal.

In another embodiment of the invention the back washing injection system is provided within the interior of core 7 whereby a rinsing spray is directed toward the interior walls of the core 7. Centrifugal force caused by the rotation of the core 7 forces the rinse out through the holes 4 onto the bristles 5. The centrifugal force continues to direct the rinse and agglomerated particles toward the interior housing wall.

It is desired that the back washing injection system distribute the back washing fluid uniformly over the core holes 8 or the outer surface of the brush. To do this the rinse fluid should be comprised of fine droplets which impinged uniformly over the entire length of the inside surface of the brush core or over the outside surface of the brush. The fine droplets may be produced by nebulizer nozzles. Rotation of the brush will help to insure that uniform distribution occurs. The rinse fluid may be any type of fluid that is actionable with the particles. For example, the rinse fluid can be water, or a solvent that dissolves particles embedded in the bristles causing the particles to be separated from the bristles.

In an alternate embodiment of the invention the brushes are rinsed by nebulizing/atomizing nozzles within the housing 6 and the rinse is sprayed toward the outer periphery of the bristles 5. This spray flows in the same direction into the brush as the gas to be purified. Then after flowing into the bristles, centrifugal force flings the fluid and particles previously entrained within the bristles toward the interior of the housing walls and down a sump 20. When it is desired to drain the sump, the accumulated material is removed through a drain 21.

The present invention may optionally include a self-pumping element 22 to maintain gas flow through the system. This is accomplished by using, for example, a centrifugal pump or other rotating pump means (e.g., vacuum pump) at the outlet of the housing 16, the pump being coupled to and rotating with the rotating shaft 5. The gas purifying system rotates at an operating speed sufficient to drive the pump and maintain desired centripetal gas flow within the system.

The foregoing description of a preferred embodiment of the invention has been presented for purposes of illustration and description. It is not intended to be exhaustive or to limit the invention to the precise form disclosed, and obviously many modifications and variations are possible in light of the above teaching. The embodiments described explain the principles of the invention and practical application and enable others skilled in the art to utilize the invention in various embodiments and with various modifications as are suited to the particular use contemplated. It is intended that the scope of the invention be defined by the claims appended hereto.

1. A method for removing particulates from a gas comprising:
directing a gas containing particulates into a housing at a first pressure;
providing a rotating hollow core within the housing, the hollow core having bristles attached thereto, and further having holes on a portion of the core;
providing a second pressure within an interior of the hollow core, the second pressure being less than said the first pressure thereby creating a centripetal force upon the gas toward the hollow core interior, the gas entering the core interior through the shaft holes;
creating a centrifugal force from said rotating core and bristles whereby the rotating bristles contact the particulates contained in the gas and direct the particulates away from the core toward an interior wall of the housing;
exhausting gas from the interior of the hollow core; and
removing accumulated particulates from within the housing.

2. The method of claim 1 further comprising removing particulates embedded within the bristles with a washing system contained within the core interior.

3. The method of claim 2 wherein the washing system is comprised of a plurality of nozzles for nebulizing a rinse agent.

4. The method of claim 3 wherein the rinse agent is water.

5. The method of claim 3 wherein the rinse agent is a solvent capable of dissolving particulates embedded in the bristles.

6. The method of claim 2 wherein the back washing system is within the housing.

7. The method of claim 1 wherein the rotating shaft has a horizontal axis of rotation.

8. The method of claim 1 further comprising pumping the gas through the housing with a pump driven by the rotating shaft.

9. The method of claim 1 further comprising segregating gas within the interior of the hollow core from the gas containing particulates within the housing.

10. A gas purifying system for removing particulates from a gas stream, comprising:
a housing having at least one gas inlet through which a particulate laden gas enters at a first pressure, said housing adapted to contain a rotatable hollow core;
said hollow core having an interior, at least one port and bristles attached to an exterior of said hollow core;
means for creating and maintaining a second pressure within said shaft interior which is less than said first pressure, thereby creating a pressure differential and centripetal force on said particulate laden gas;
a rotation system drivably rotating the hollow core and bristles, said bristles contacting particulates entrained with the particulate laden gas, thereby separating particulates from the gas, said contacted particulates being directed toward an inner surface of said housing through centrifugal force and while the gas flows under centripetal force toward an interior of the core and a housing outlet.

11. The system of claim 10 further comprising a means for rinsing particulates from said bristles.

12. The system of claim 11 wherein the rinsing means is a water.

13. The system of claim 11 wherein the rinsing means is a solvent.

14. The system of claim 10 further comprising pumping means for maintaining said pressure within said shaft at a level below said first pressure.

15. The system of claim 14 wherein said pumping means is a self-pumping means drivably connected to said rotating shaft.

16. The system of claim 11 further comprising means for segregating the gas within the hollow core interior from the gas containing particulates within the housing.

17. The system of claim 16 wherein the means for segregating the gas is a carbon ring seal and bellows.

18. The system of claim 11 further comprising a waste collection system connected to said housing for collecting and removing accumulated particulates from within said housing.

19. A system for removing particulates from a gas stream, comprising:
a housing having first and second ends, each end having an aperture, the housing further having at least one gas inlet through which a gas containing particulates enters the housing at a first pressure;
a rotatable hollow core positioned through the first and second end apertures, a portion of the core being within said housing and having holes, a pressure within the core being less that the first gas pressure;
bristles attached to, and extending from, the core;
a rotation system drivably rotating the hollow fore and bristles, thereby creating a centrifugal force to direct particulates which contact the rotating bristles toward an inner surface of the housing, while gas flows under centripetal force toward an interior of the core.
